(19) United States
(12) Patent Application Publication
(10) Pub. No.: US 2002/0167568 A1
(43) Pub. Date: Nov. 14, 2002

(54) Head tip

(76) Inventor: Katsuhisa Sakuma, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/061,121

(22) Filed: Jan. 31, 2002

(30) Foreign Application Priority Data
Mar. 1, 2001 (JP) 2001-057275
Jul. 27, 2001 (JP) 2001-227591

(51) Int. Cl. B41J 2/045

(52) U.S. Cl. 347/68

(57) ABSTRACT

To provide a head tip in which the convergence time for attenuation of the pressure inside the chamber is reduced to thereby make it possible to achieve an increase in printing speed, a head tip 11 having a structure in which a driving voltage is applied to electrodes 19 formed on the side walls 18 of a chamber 17 defined by the side walls 18 on a piezoelectric ceramic plate 16, thereby changing the volume of the chamber 17 and causing ink filled in the chamber to be ejected through a nozzle opening 24, in which an ink chamber plate 20 is joined to the piezoelectric ceramic plate 16 so that a common ink chamber 21 communicating with one longitudinal end portion of the chamber 17 is defined, and in which a border portion where the chamber 17 and the common ink chamber 21 communicate with each other creates flow passage resistance in the ink.

### BACKGROUND OF THE INVENTION

1. Field of the Invention

The present invention relates to a head tip to be mounted in an ink-jet type recording apparatus applicable to a printer, a facsimile machine or the like.

2. Description of the Related Art

An ink-jet type recording apparatus has been known which records characters, images, etc. on a medium to be recorded by using an ink-jet head having a plurality of nozzles ejecting ink. In such an ink-jet type recording apparatus, the ink-jet head is provided in a head holder such that the nozzles of the ink-jet head are opposed to the medium to be recorded, and the head holder is mounted on a carriage, scanning being performed in a direction perpendicular to the direction in which the medium to be recorded is conveyed.

FIG. 11 is a schematic exploded view of an example of the head tip of such an ink-jet head, and FIG. 12 is a sectional view of a main portion thereof. As shown in FIGS. 11 and 12, a plurality of grooves 102 are provided side by side in a piezoelectric ceramic plate 101, the grooves 102 being separated from each other by side walls 103. One longitudinal end portion of each groove 102 extends to one end surface of the piezoelectric ceramic plate 101, and the other end portion thereof does not extend to the other end surface, the depth of the groove gradually decreasing. Longitudinally extending electrodes 105 for driving electric field application are formed on the opening-side surfaces of the side walls 103 of each groove 102.

Further, a cover plate 107 is joined to the side of the piezoelectric ceramic plate 101 where the grooves 102 are open through the intermediation of an adhesive 109. The cover plate 107 has a common ink chamber 111 constituting a recess communicating with the shallow end portions of the grooves 102 and an ink supply port 112 extending from the bottom of the common ink chamber 111 to the side opposite to the grooves 102.

A nozzle plate 115 is joined to the end surface of the joint unit of the piezoelectric ceramic plate 101 and the cover plate 107 where the grooves 102 are open, and nozzle openings 117 are formed at positions of the nozzle plate 115 opposed to the grooves 102.

A wiring base plate 120 is fastened to the surface of the piezoelectric ceramic plate 101 on the side opposite to the cover plate 107 and on the side opposite to the nozzle plate 115. Formed on the wiring base plate 120 is wiring 122 connected by the electrodes 105, bonding wires 121, etc., and a driving voltage can be applied to the electrodes 105 through this wiring 122.

In this head tip, constructed as described above, the grooves 102 is filled with ink from the ink supply port 112. When a predetermined driving electric field is caused to act on the side walls 103 of a predetermined groove 102 through the electrodes 105, the side walls 103 undergo deformation and the volume of the predetermined groove 102 changes, whereby ink in the groove 102 is ejected from the nozzle opening 117.

For example, when, as shown in FIG. 13, ink is to be ejected through the nozzle opening 117 corresponding to a groove 102a, positive drive voltage is applied to electrodes 105a and 105b in the groove 102a, and electrodes 105c and 105d respectively opposed thereto are grounded, whereby a driving electric field directed to the groove 102a is applied to side walls 103a and 103b. When this is orthogonal to the polarization direction of the piezoelectric ceramic plate 101, the side walls 103a and 103b are deformed toward the groove 102a by the piezoelectric thickness slippage effect, and the volume of the groove 102a decreases to cause an increase in pressure, thereby causing ink to be ejected through the nozzle opening 117.

In such a head tip, the period of time between the moment at which the oscillation of the side walls due to ink ejection stops and the moment at which the ink pressure inside the groove is reduced to zero to make the groove ready for next ink ejection depends on the length of the groove, the configuration of the nozzle opening, etc. Due to the low hermeticity of the groove, sound pressure is repeatedly reflected in the groove, and it takes time for the reflection to completely attenuate. Thus, it is difficult to achieve an increase in the speed of repeated ejection, that is, an increase in printing speed.

### SUMMARY OF THE INVENTION

In view of the above problem, it is an object of the present invention to provide a head tip in which the convergence time for attenuation of the pressure inside the chamber is reduced to thereby make it possible to achieve an increase in printing speed.

According to a first aspect of the present invention for solving the above-mentioned object, there is provided a head tip having a structure in which a driving voltage is applied to electrodes formed on side walls of a chamber defined by the side walls on a base plate, thereby changing the volume of the chamber and causing ink filled in the chamber to be ejected through a nozzle opening, wherein an ink chamber plate is joined to the base plate so that a common ink chamber communicating with one longitudinal end portion of the chamber is defined, and a border portion where the chamber and the common ink chamber communicate with each other creates flow passage resistance in the ink.

According to a second aspect of the present invention, in a first aspect of the present invention, the head tip is characterized in that the border portion has a plurality of through-holes.

According to a third aspect of the present invention, in a first aspect of the present invention, the head tip is characterized in that the border portion is of a net-like construction.

According to a fourth aspect of the present invention, in a first aspect of the present invention, the head tip is characterized in that the border portion includes a plate-like construction situated substantially at the center of the border portion and narrower than the longitudinal dimension of the border portion.

According to a fifth aspect of the present invention, in a first aspect of the present invention, the head tip is characterized in that: the base plate is formed of a piezoelectric ceramic plate in which grooves are formed to thereby define the chamber, and that communication of the chamber with the common ink chamber is effected through an opening at one longitudinal end of the chamber and on the opposite side of the base plate.

According to a sixth aspect of the present invention, in a first aspect of the present invention, the head tip is characterized in that: the side walls formed of a piezoelectric ceramic are arranged on the base plate at predetermined intervals to define the chamber between the side walls, and that common ink chamber is defined on the base plate, the chamber and the common ink chamber communicating with each other at one longitudinal end of the chamber.

In the present invention, the border portion between the chamber and the common ink chamber creates flow passage resistance, thereby making it possible to enhance the hermeticity of the chamber. This makes it possible to reduce the convergence time for attenuation of the pressure inside the chamber, thereby expediting successive ink ejection and achieving an increase in printing speed.

### BRIEF DESCRIPTION OF THE DRAWINGS

In the accompanying drawings:

FIG. 1 is an assembly perspective view of an ink-jet head according to Embodiment 1 of the present invention;

FIGS. 2A and 2B are exploded perspective views of a head tip according to Embodiment 1 of the present invention;

FIGS. 3A to 3D are sectional views of the head tip according to Embodiment 1 of the present invention, of which FIG. 3A is a longitudinal sectional view of the chamber, FIG. 3B is a sectional view taken along the line A-A′ of FIG. 3A, FIG. 3C is a longitudinal sectional view of the chamber of another example of what is shown in FIG. 3A, and FIG. 3D is a sectional view taken along the line N-N′ of FIG. 3C;

FIGS. 4A and 4B are perspective views showing an assembly process for an ink-jet head according to Embodiment 1 of the present invention;

FIG. 5 is an exploded perspective view of a head tip according to Embodiment 2 of the present invention;

FIGS. 6A and 6B are sectional views of a head tip according to Embodiment 2 of the present invention, of which FIG. 6A is a longitudinal sectional view of the chamber, and FIG. 6B is a sectional view taken along the line B-B′ of FIG. 6A;

FIG. 7 is an exploded perspective view of a head tip according to Embodiment 3 of the present invention;

FIGS. 8A and 8B are sectional views of a head tip according to Embodiment 3 of the present invention, of which FIG. 8A is a sectional view taken along the chamber arrangement direction, and

FIG. 8B is a sectional view taken along the line C-C′ of FIG. 8A;

FIGS. 9A and 9B are exploded perspective views schematically showing a head unit according to another embodiment of the present invention;

FIG. 10 is a schematic perspective view of an ink-jet type recording apparatus according to another embodiment of the present invention;

FIG. 11 is a perspective view schematically showing a conventional head tip;

FIGS. 12A and 12B are exploded perspective views schematically showing a conventional head tip; and

FIG. 13 is a sectional view schematically showing a conventional head tip.

### DETAILED DESCRIPTION OF THE PREFERED EMBODIMENTS

Embodiments of the present invention will now be described in detail.

(Embodiment 1)

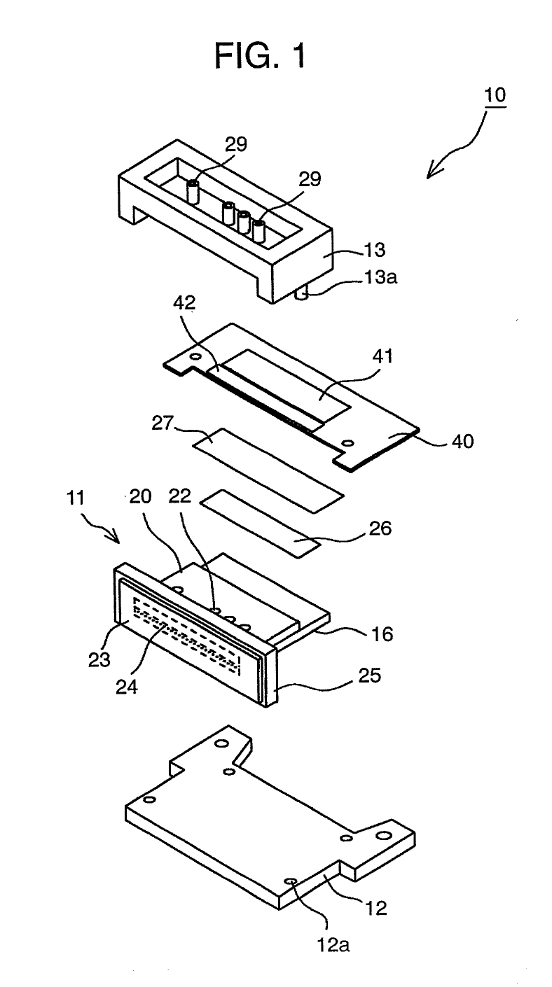

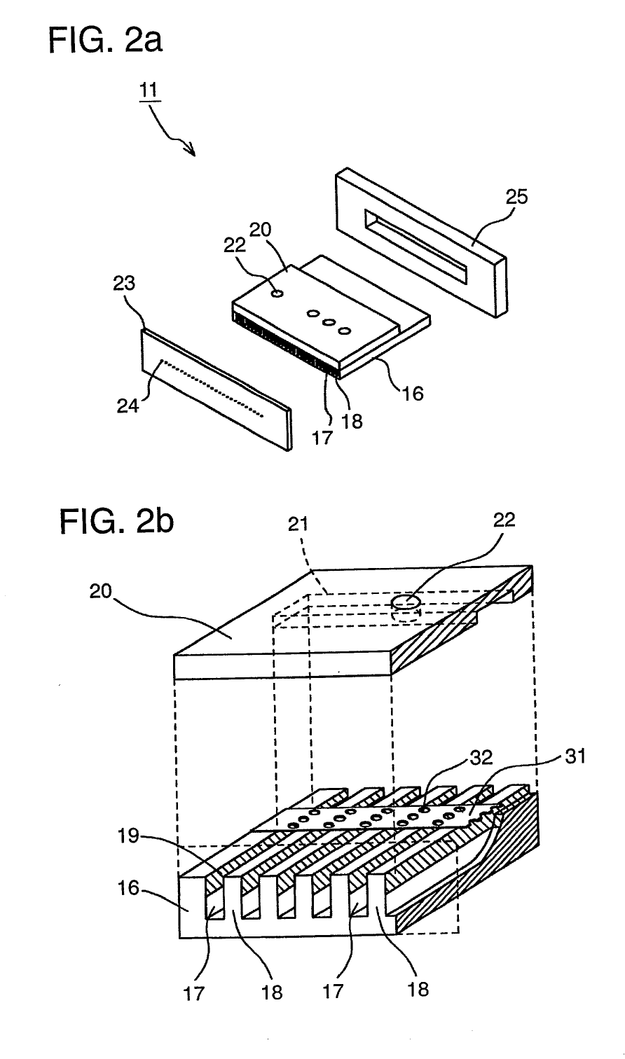

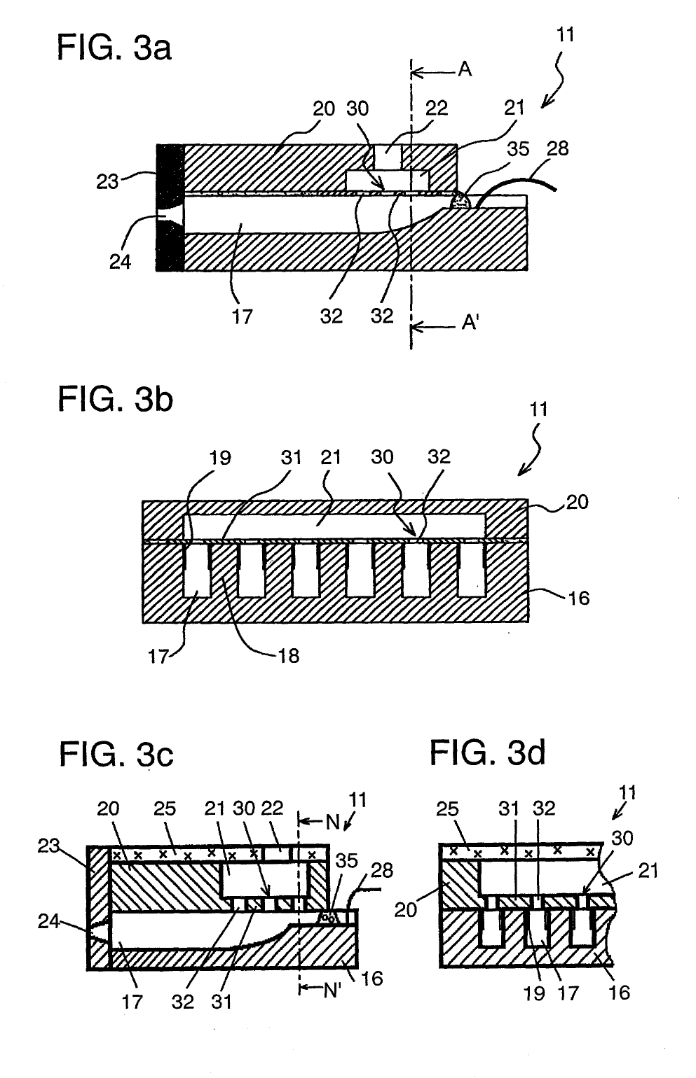

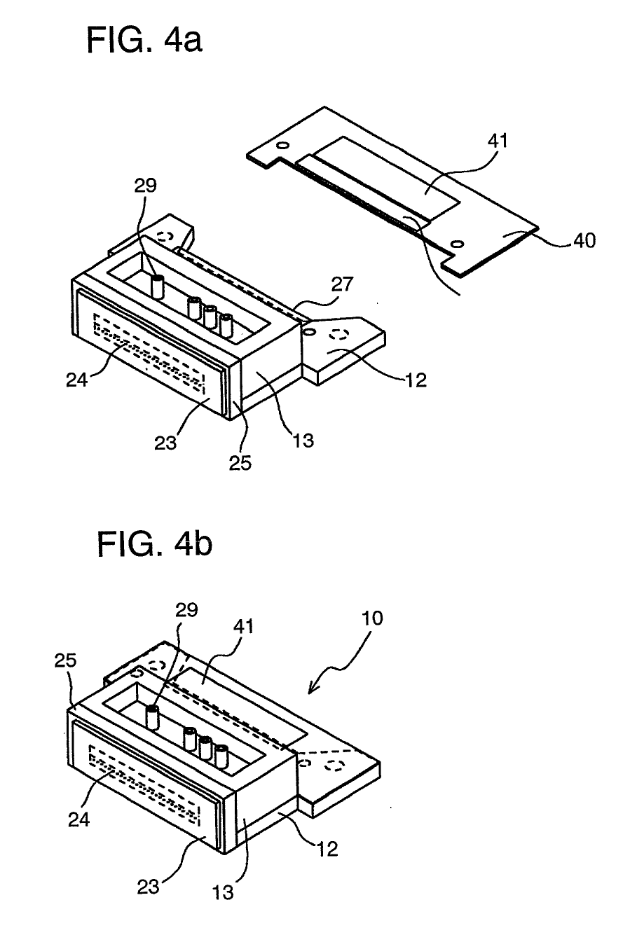

FIG. 1 is an exploded perspective view of an ink jet head according to an embodiment; FIG. 2 is an exploded perspective view of a head tip; FIG. 3A is a longitudinal sectional view of a chamber of a head tip; FIG. 3B is a sectional view taken along the line A-A′ of FIG. 3A; FIG. 3C is a longitudinal sectional view of another example of a chamber of a head tip as shown FIG. 3A; and FIG. 3D is a sectional view taken along the line N-N′ of FIG. 3C. FIG. 4 is a schematic perspective view showing an assembly process for an ink jet head.

As shown in FIG. 1, the ink jet head 10 of this embodiment comprises a head tip 11, a base plate 12 provided on one side of the head tip 11, a head cover 13 provided on the other side of the head tip 11, and a wiring base plate 40 on which a driving circuit 41 for driving the heat tip 11 is mounted.

First, the head tip 11 will be described in detail. As shown in FIGS. 2, 3A, and 3B, in a piezoelectric ceramic plate 16 constituting the head tip 11, chambers 17 consisting of a plurality of grooves are arranged side by side, the chambers 17 being separated from each other by sidewalls 18. One end portion in the longitudinal direction of each chamber 17 extends to one end surface of the piezoelectric ceramic plate 16, and the other end portion thereof does not extend to the other end surface, with its depth gradually decreasing. Longitudinally extending electrodes 19 for driving electric field application are formed on the opening-side surfaces of the side walls 18 of each chamber 17.

Each of the chambers 17 formed in the piezoelectric ceramic plate 16 is formed, for example, by a disc-shaped dice cutter, the portions where the depth gradually decreases being formed in conformity with the configuration of the dice cutter. The electrodes 19 formed in the chambers 17 are formed, for example, by a well-known oblique evaporation method or the like.

An ink chamber plate 20 is joined to the side of the piezoelectric ceramic plate 16 where the chambers 17 are open through the intermediation of an adhesive. The ink chamber plate 20 has a common ink chamber 21 constituting a recess communicating with the shallow other end portions of the chambers 17, and an ink supply port 22 extending from the bottom of the common ink chamber 21 to the side opposite to the chambers 17.

In this embodiment, each of the chambers 17 is classified into four groups corresponding to the colors of black (B), yellow (Y), magenta (M), and cyan (C), and there are provided four common ink chambers 21 and four ink supply ports 22.

The ink chamber plate 20 can be formed of a ceramic plate, a metal plate or the like. Taking into account the deformation after its join to the piezoelectric ceramic plate 16, etc., it is desirable to use a ceramic plate, whose coefficient of thermal expansion is akin to that of the piezoelectric ceramic plate.

A border portion 30 where the chambers 17 of the piezoelectric ceramic plate 16 communicated with the common ink chamber 21 of the ink chamber plate 20 had a resistance structure 31 creating flow passage resistance in the ink passing through the border portion 30. This resistance structure 31 creates flow passage resistance in the ink passing through the border portion 30 to enhance the A hermeticity of the chambers 17, thereby reducing the convergence time for attenuation of the pressure generated as a result of repeated reflection of sound pressure inside the chambers 17 after the stopping of the oscillation of the side walls 18 after ink ejection.

There is no particular limitation regarding the resistance structure 31 as long as flow passage resistance can be generated in the ink passing through the border portion 30 between the chambers 17 and the common ink chamber 21. In this embodiment, the area of communication of the border portion 30 through which the chambers 17 and the common ink chamber 21 communicate with each other is reduced, thereby creating flow passage resistance in the ink passing through the border portion 30.

More specifically, as shown in FIGS. 3A and 3B, the resistance structure 31 of this embodiment consists of a plate-like member which has a plurality of through-holes 32 at a position opposed to each border portion 30 and which extends in the direction in which the border portions 30 are arranged.

The means for making the area of communication of the border portions 30 small by the resistance structure 31 is not restricted to the above-described one. For example, it is also possible to provide a plate-like member having a plurality of through-holes 32 cut up corresponding to each border portion 30 for each border portion 30. Further, the through-holes 32 may be of rectangular, lattice-like, or honeycomb-like configuration.

Further, as shown in FIGS. 3C and 3D, it is also possible to adopt a construction in which the resistance structure 31 is integrated with the ink chamber plate 20.

Further, there is no particular limitation regarding the resistance structure 31 as long as it is possible to-create flow passage resistance in the ink passing through the border portions 30. For example, it is also possible to use a net-like member.

In any case, due to the fact that the border portions 30 between the chambers 17 and the common ink chamber 21 have the resistance structure 31, it is possible to create flow passage resistance in the ink passing through the border portions 30 and to enhance the hermeticity of the chambers 17.

The flow passage resistance created in the ink passing through the border portions 30 by the resistance structure 31 is appropriately determined according to the size, configuration, etc. of the nozzle openings, chambers, and border portions described below such that ink can be smoothly supplied from the common ink chamber 21 to the chambers 17.

A nozzle plate 23 is joined to the end surface of the joint unit of the piezoelectric ceramic plate 16 and the ink chamber plate 20 where the chambers 17 are open, and a nozzle opening 24 is formed in the nozzle plate 23 at the position opposed to each of the chambers 17.

In this embodiment, the area of the nozzle plate 23 is larger than the area of the end surface of the joint unit of the piezoelectric ceramic plate 16 and the ink chamber plate 20 where the chambers 17 are open. This nozzle plate 23 consists, for example, of a polyimide film, and the nozzle openings 24 are formed therein by using an excimer laser device or the like. Further, although not shown, there is provided on the surface of the nozzle plate 23 opposing the object on which printing is to be performed a water-repellent film for preventing adhesion of ink, etc.

In this embodiment, a nozzle support plate 25 is arranged around the end portion of the joint unit of the piezoelectric ceramic plate 16 and the ink chamber plate 20 where the chambers 17 are open. This nozzle support plate 25 is joined to the portion of the nozzle plate 23 outside the end surface of the joint unit to thereby hold the nozzle plate 23 in a stable manner. Of course, it is not absolutely necessary to provide this nozzle support plate 25.

When forming the head tip 11, constructed as described above, the piezoelectric ceramic plate 16 and the ink chamber plate 20 are first joined to each other, and the nozzle plate 23 is joined to the end surface of the joint unit. Then, the nozzle support plate 25 is fitted onto the outer side surface of the nozzle plate 23 and the joint unit of the piezoelectric ceramic plate 16 and the ink chamber plate 20.

Table 1 shows how, in the head tip 11 having this resistance structure 31, the convergence time for attenuation of the pressure in the chambers 17 varies with the flow passage resistance of the resistance structure 31.

In this embodiment, the pump length of the chambers 17 was 1.6 mm, the length of the border portions 30 of the chambers 17 was 5.55 mm, the depth of the chambers 17 was 0.36 mm, and the area of the border portions 30 was 4.33×10⁻¹ mm², and a predetermined oscillation was imparted to the nozzle plate 23, with the nozzle plate 23 side end surfaces of the chambers 17 being closed (The nozzle plate 23 was provided with no nozzle openings 24), to obtain by analysis the convergence time for the oscillation to attenuate in the chambers 17 to a level not higher than 8.00×10⁻⁸ Pa. The convergence time for attenuation when the flow passage resistance is 0% was used as a reference.

TABLE 1

| | | | | |
|---|---|---|---|---|
| Flow passage resistance | 0% | 20% | 40% | 60% |
| Convergence time for | 100% | 89% | 74% | 62% |
| attenuation | | | | |
| (Reference is when flow | | | | |
| passage resistance is 0%) | | | | |

| | |
|---|---|
| Convergence condition | 8.00 × 10⁻⁸ |
| (Pa) | |

As shown in Table 1, when, for example, a flow passage resistance of 20% is created in the ink passing through the border portions 30 due to the presence of the resistance structure 31, the convergence time for attenuation of the pressure in the chambers 17 after ink ejection can be reduced to 89% as compared with the prior art. In this way, in the head tip 11 of this embodiment, it is possible to attenuate the pressure in the chambers 17 to the initial level (not higher than 8.00×10⁻⁸ Pa) in a short time, so that ink can be successively ejected at shorter intervals, thereby achieving an increase in printing speed.

In the following, the ink-jet head 10 of this embodiment using the above-described head tip 11 will be described.

As shown in FIGS. 1 and 4, in the ink-jet head 10 of this embodiment, there is formed at the end of the piezoelectric ceramic plate 16 constituting the head tip 11 on the side opposite to the nozzle openings 24 a wiring pattern (not shown) connected to the electrodes 19 through bonding wires 28 or the like, and a flexible cable 27 is connected to this wiring pattern through the intermediation of an anisotropic conductive film 26. Further, at the rear end side of the nozzle support plate 25 of the joint unit of the piezoelectric ceramic plate 16 and the ink chamber plate 20, there are mounted the aluminum base plate 12 on the piezoelectric ceramic plate 16 side and the head cover 13 on the ink chamber plate 20 side. The base plate 12 and the head cover 13 are fixed to each other by engaging engagement shafts 13a of the head cover 13 with engagement holes 12a of the base plate 12, the two components holding therebetween the joint unit of the piezoelectric ceramic plate 16 and the ink chamber plate 20. The head cover 13 is provided with ink introducing ducts 29 respectively communicating with ink supply ports 22 of the ink chamber plate 20.

Further, as shown in FIG. 4A, the wiring base plate 40, is fastened to the base plate 12 protruding on the rear end side of the piezoelectric ceramic plate 16. The driving circuit 41 consisting of an integrated circuit or the like for driving the head tip 11 is mounted on the wiring base plate 40, and the driving circuit 41 and the flexible cable 27 are connected to each other through an anisotropic conductive film 42, whereby the ink-jet head 10 as shown in FIG. 4B is completed.

In this ink-jet head 10, each of the chambers 17 is filled with ink supplied through the ink introducing ducts 29 from the ink supply port 22, and a predetermined driving electric field is caused to act on the side walls 18 of a predetermined chamber 17 through the electrodes 19 by the driving circuit 41, whereby the side walls 18 undergo deformation and the volume of the predetermined chamber 17 is changed, whereby ink in the chamber 17 is ejected through the nozzle opening 24.

(Embodiment 2)

In Embodiment 1 described above, the resistance structure 31 consists of a plate-like member provided in the border portions 30 between the chambers 17 and the common ink chamber 21 and having a plurality of through-holes 32 in the regions corresponding to the border portions 30. In Embodiment 2, the resistance structure consists of a plate-like member narrower than the longitudinal dimension of the border portions 30 and provided substantially at the longitudinal center of the border portions 30.

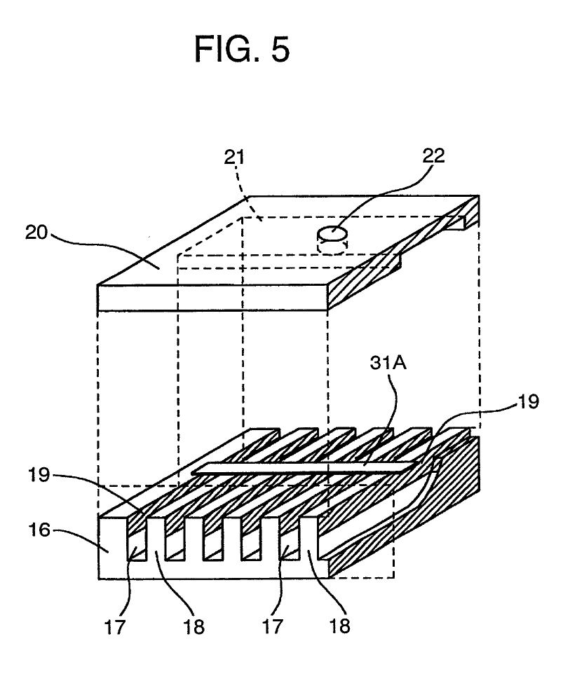

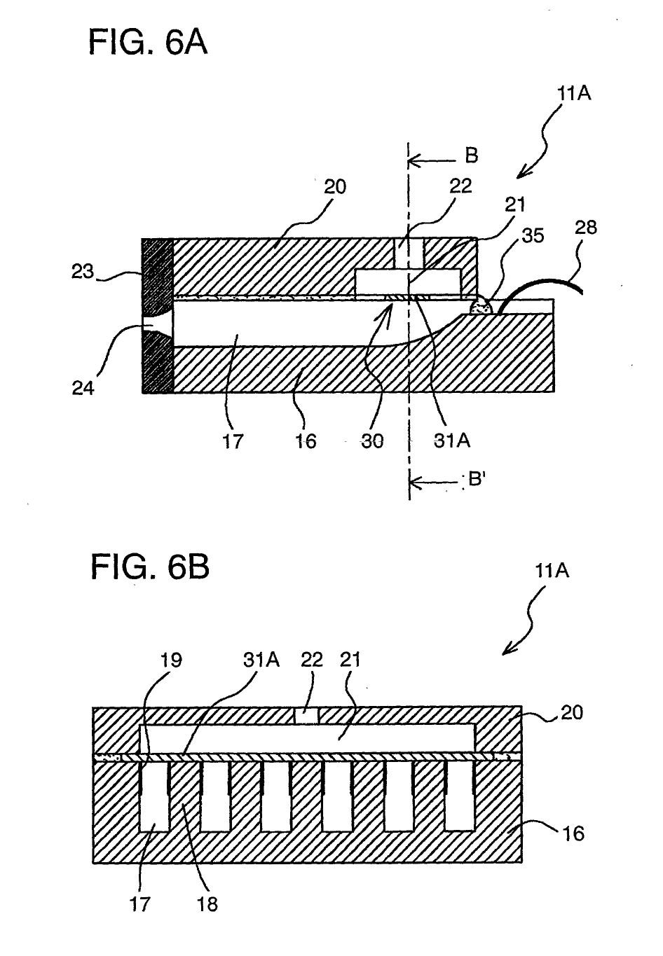

FIG. 5 is an exploded perspective view of a head tip according to Embodiment 2; FIG. 6A is a longitudinal sectional view of a chamber of the head tip; and FIG. 6B is a sectional view taken along the line B-B′ of FIG. 6A.

As shown in the drawings, the resistance structure 31A of this embodiment consists of a plate-like member narrower than the longitudinal dimension of the border portions 30 between the chambers 17 and the common ink chamber 21. This resistance structure 31A is the same as that of Embodiment 1 described above except that it is provided substantially at the longitudinal center of the border portions 30 so that the chambers 17 and the common ink chamber 21 may communicated with each other at the longitudinal end portions side of the border portions 30.

Further, as in Embodiment 1 described above, the resistance structure 31A may be integrated with the ink chamber plate 20.

When this resistance structure 31A is provided on the nozzle plate 23 side of the border portions 30, the pump length of the chambers 17 is rather large, and the convergence time for attenuation of the pressure in the chambers 17 is rather long. On the other hand, when the resistance structure 31A is provided on the end portion side where the depth of the chambers 17 decreases, bubbles of ink supplied from the common ink chamber 21 are accumulated in the shallow end portions of the chambers 17. Thus, it is desirable for the resistance structure 31A to be provided substantially at the center of the border portions 30 so that the chambers 17 and the common ink chamber 21 may communicate with each other at the longitudinal ends of the border portions 30.

This resistance structure 31A is also capable of creating flow passage resistance in the ink passing through the border portions 30 between the chambers 17 and the common ink chamber 21, thereby making it possible to enhance the hermeticity of the chambers 17. Thus, it is possible to reduce the convergence time for attenuation of the pressure inside the chambers 17.

(Embodiment 3)

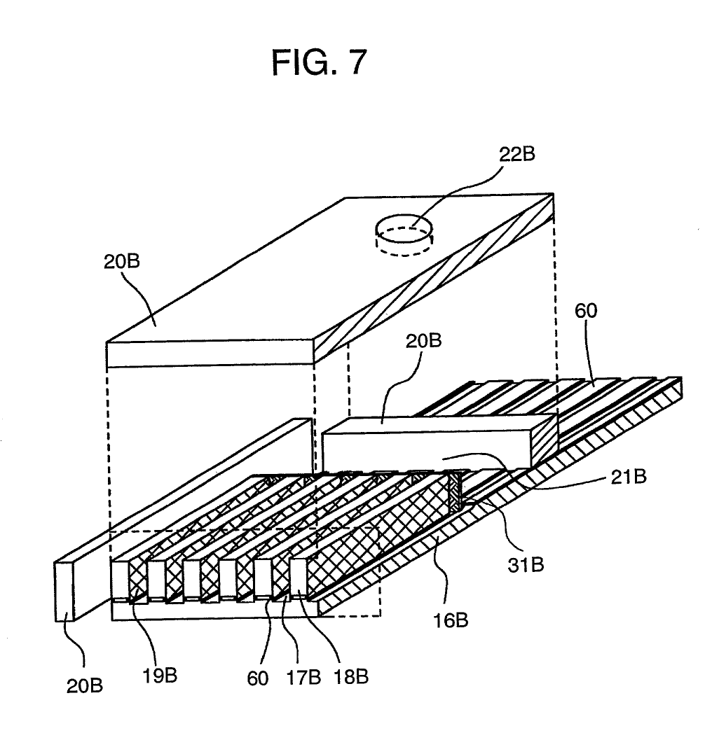

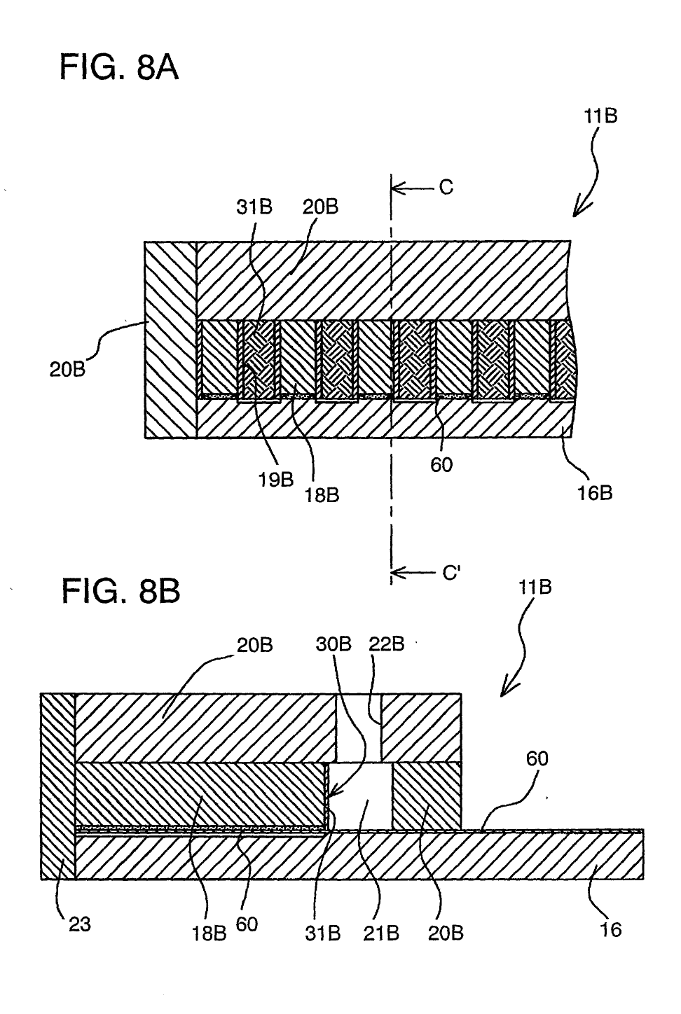

FIG. 7 is an exploded perspective view of a head tip according to Embodiment 3; FIG. 8A is a sectional view of the head tip taken along the width direction; and FIG. 8B is a sectional view taken along the line C-C′ of FIG. 8A.

As shown in the drawings, in a head tip 11B of this embodiment, side walls 18B formed of piezoelectric ceramic are arranged at predetermined intervals on a base plate 16B, and chambers 17B are defined between the side walls 18B, a common ink chamber 21B being defined on the base plate 16B by a plurality of ink chamber plates 20B so as to communicate at one longitudinal end of the chambers 17B.

Border portions 30B at one end of the chambers 17B where the chambers 17B communicate with the common ink chamber 21B are the same as those of Embodiment 1 described above except that there is provided a resistance structure 31B creating flow passage resistance in the ink passing through the border portions 30B.

It goes without saying that the resistance structure 31B may be integrated with the side walls 18B as in Embodiment 1 described above.

As shown in FIG. 8, the resistance structure 31B of this embodiment consists of a net-like member provided in the direction in which the border portions 30B are arranged.

Table 2 shows how, in the head tip 11B having this resistance structure 31B, the convergence time for attenuation of the pressure in the chambers 17B varies with the flow passage resistance of the resistance structure 31B.

In this embodiment, the longitudinal length of the chambers 17B was 1.6 mm, the depth of the chambers 17 was 0.36 mm, and the area of the border portions 30B (a transverse cross section of the chamber 17B) was 2.81×10⁻² mm², and a predetermined oscillation was imparted to the nozzle plate 23, with the nozzle plate 23 side end surfaces of the chambers 17B being closed (The nozzle plate 23 was provided with no nozzle openings 24), to obtain by analysis the convergence time for the oscillation to attenuate in the chambers 17B to a level not higher than 8.00×10⁻⁸ Pa. The convergence time for attenuation when the flow passage resistance is 0% was used as a reference.

TABLE 2

| | | | | |
|---|---|---|---|---|
| Flow passage resistance | 0% | 20% | 40% | 60% |
| Convergence time for attenuation | 100% | 82% | 67% | 56% |
| (Reference is when flow passage | | | | |
| resistance is 0%) | | | | |
| Convergence time for attenuation | 62% | 51% | 42% | 35% |
| (Reference is when flow passage | | | | |
| resistance of Embodiment 1 is 0%) | | | | |

| | |
|---|---|
| Convergence condition (Pa) | 8.00 × 10⁻⁸ |

As shown in Table 2, when, for example, a flow passage resistance of 20% is created in the ink passing through the border portions 30B due to the presence of the resistance structure 31B, the convergence time for attenuation of the pressure in the chambers 17B after ink ejection can be reduced to 82% as compared with the prior art. In this way, in the head tip 11B of this embodiment, it is possible to attenuate the pressure in the chambers 17B to the initial level (not higher than 8.00×10⁻⁸ Pa) in a short time, so that ink can be successively ejected at shorter intervals, thereby achieving an increase in printing speed.

Further, as compared with Embodiment 1, the area of the opening of the border portions 30B where the chambers 17B communicate with the common ink chamber 21B is smaller, so that, in this embodiment, even if the flow passage resistance is the same, a substantial reduction in convergence time for attenuation can be achieved as compared with the case of Embodiment 1 shown in Table 1.

Electrodes 19B provided on the side walls 18B of the chambers 17B of this embodiment are connected to the driving circuit 41 by wiring 60 provided on the base plate 16B. In this embodiment, the conduction between the electrodes 19B and the wiring 60 is achieved, for example, as follows. The wiring 60 extends along the chambers 17B defined by the base plate 16B and the side walls 18B, and the widthwise end portion of the wiring 60 thus extending is reliably held in contact with the electrodes 19B, whereby the conduction between the electrodes 19B and the wiring 60 is achieved.

(Other Embodiments)

The head tip of the present invention is not restricted to the constructions of Embodiments 1 through 3 described above.

For example, while in Embodiments 1 through 3 described above the resistance structures 31, 31A, and 31B consist of a plate-like member having a plurality of through-holes 32 and a plate-like member and a net-like member narrower than the border portions 30, there is no particular limitation regarding the construction of the resistance structure as long as flow passage resistance is created in the ink filling the chambers 17 and 17B by the border portions 30.

This ink-jet head 10 is mounted to a tank holder 51 holding an ink cartridge (not shown) to form a head unit 50.

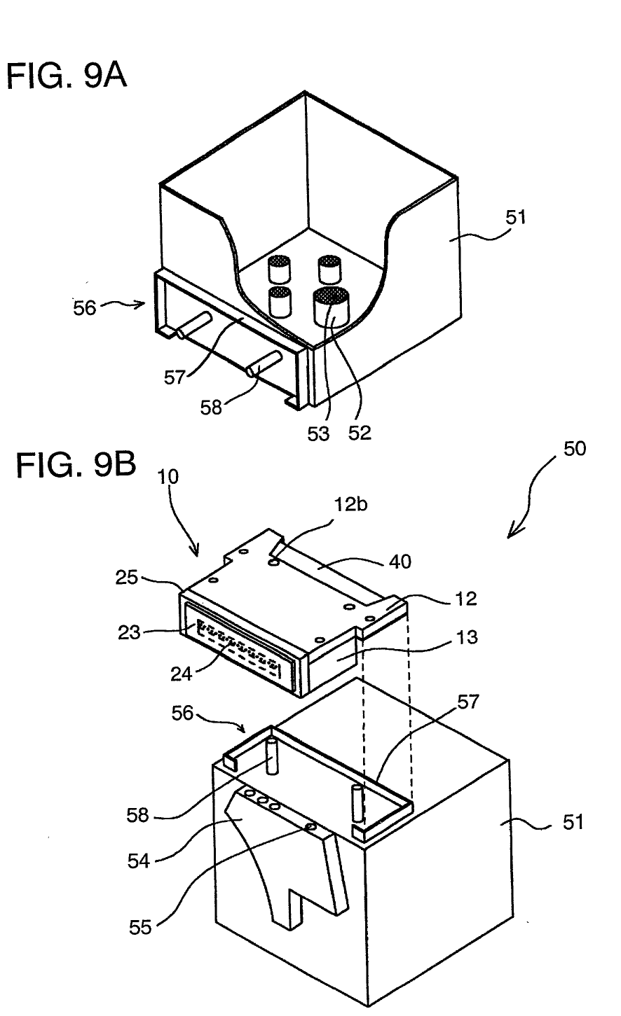

FIG. 9 shows an example of the tank holder 51. The tank holder 51 shown in FIG. 9 is substantially formed as a box with one side open and is capable of detachably holding an ink cartridge. On the upper surface of its bottom wall, there is provided a connecting portion 52 connecting with the ink supply port 22 which is an opening formed at the bottom of the ink cartridge. The connecting portion a 52 is provided for each of the inks of colors, for example, of black (B), yellow (Y), magenta (M), and cyan (C). An ink flow passage (not shown) is formed in the connecting portion 52, and at the forward end of the connecting portion 52 constituting its opening, there is provided a filter 53. The ink flow passage formed in the connecting portion 52 communicates with the back surface side of the bottom wall; each ink flow passage communicates through an ink flow passage (not shown) in a flow passage base plate 54 provided on the back surface side of the tank holder 51 with a head connection hole 55 open in the side wall of the flow passage base plate 54. This head connection hole 55 is open in the side surface side of the tank holder 51, and, at the bottom of the side wall, there is provided a head holding portion 56 for holding the ink jet head 10 described above. The head holding portion 56 is provided with a substantially U-shaped surrounding wall 57 surrounding the driving circuit 41 provided on the wiring base plate 40, and engagement shafts 58 situated within the surrounding wall 57 and adapted to be engaged with engagement holes 12b provided in the base plate 12 and the wiring base plate 40 of the ink jet head 10.

Thus, by mounting the ink jet head 10 on this head holding portion 56, the head unit 50 is completed. At this time, the ink introducing ducts 29 formed on the head cover 13 are connected with the head connection holes 55 of the flow passage base plate 54, whereby the ink introduced from the ink cartridge through the connecting portion 52 of the tank holder 51 is introduced to the ink introducing ducts 29 of the ink jet head 10 through the ink flow passage in the flow passage base plate 54 to fill the common ink chamber 21 and the chambers 17 after passing through the through-holes 32 of the resistance member 31.

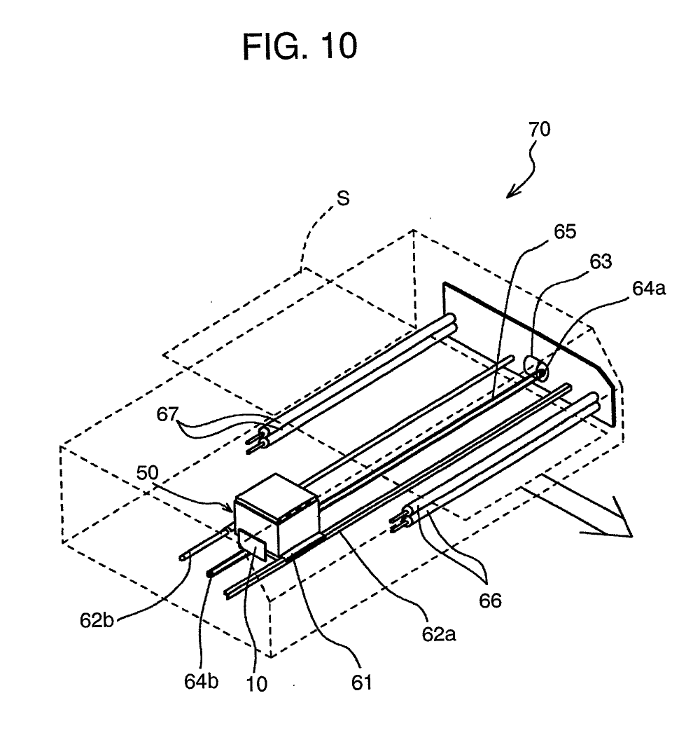

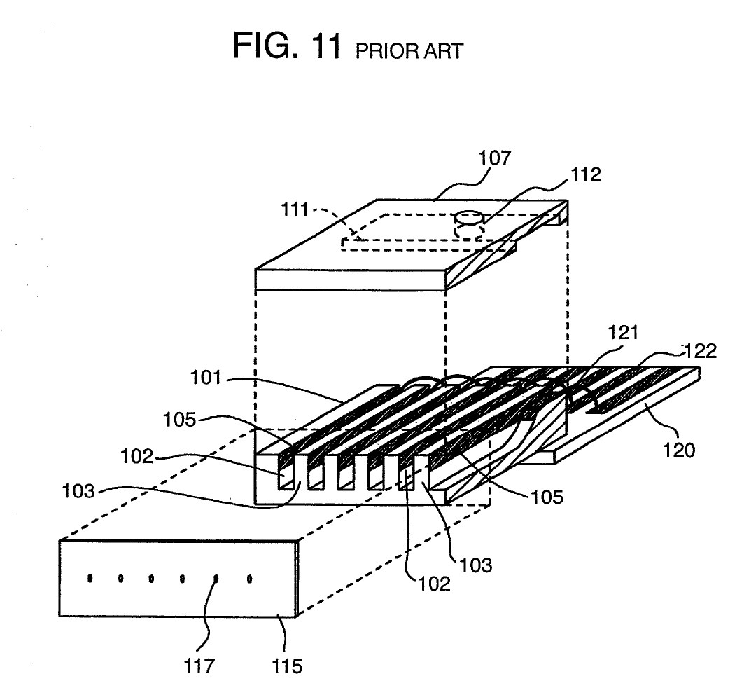

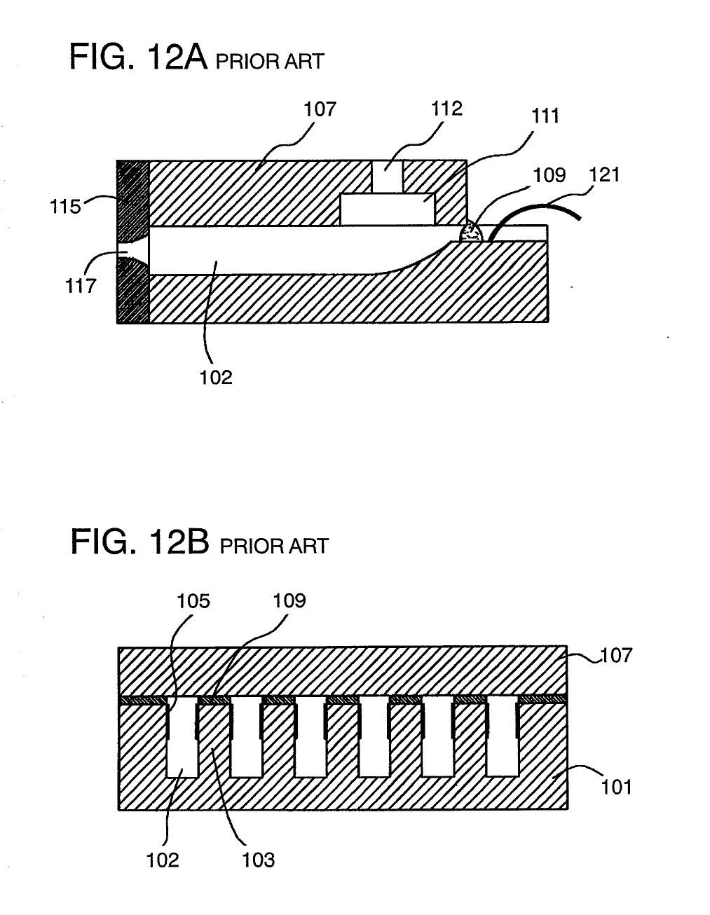

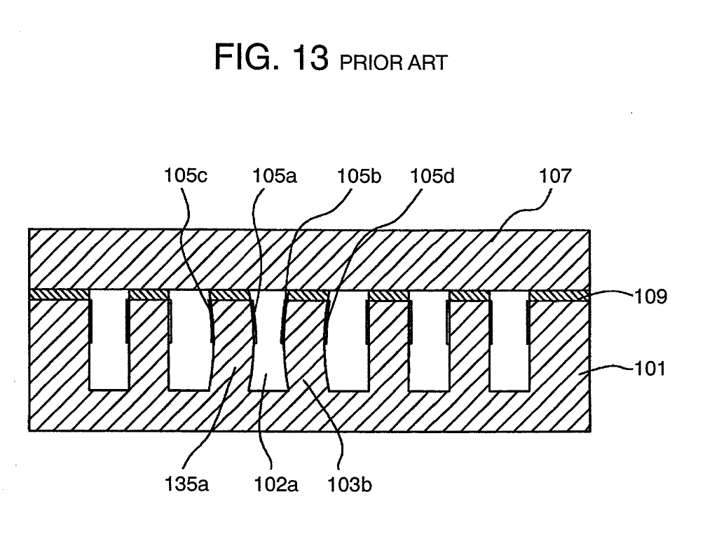

The head unit 50 thus formed is mounted, for example, on the carriage of an ink-jet type recording apparatus and is used. FIG. 10 schematically shows an example of the way this head unit is used.

As shown in FIG. 10, a carriage 61 of an ink-jet type recording apparatus 70 is mounted on a pair of guide rails 62a and 62b so as to be axially movable, and is conveyed through a timing belt 65 stretched between a pulley 64a provided at one end side of the guide rails 62 and connected to a carriage driving motor 63 and a pulley 64b provided at the other end of the rails. At the ends with respect to the direction perpendicular to the direction in which the carriage 61 is conveyed, there are provided conveying roller pairs 66 and 67 extending along the guide rails 62a and 62b. These conveying roller pairs 66 and 67 convey a medium to be recorded S below the carriage 61 and in a direction perpendicular to the direction in which the carriage 61 is conveyed.

The above-described head unit 50 is mounted on the carriage 61, and the ink carriage is detachably held by this head unit 50.

In this ink-jet type recording apparatus 70, while conveying the medium to be recorded S, the carriage 61 performs scanning in a direction perpendicular to the conveying direction, whereby it is possible to record characters and images on the medium to be recorded S by the ink-jet head 10.

As described above, in accordance with the present invention, the border portions where the chambers and the common ink chamber communicate with each other create flow passage resistance in the ink, whereby the hermeticity of the chambers is enhanced insofar as the ink can be smoothly supplied to the chambers, making it possible to reduce the convergence time for attenuation of the pressure in the chambers. Thus, the ink ejecting operation can be conducted at shorter intervals when successively ejecting ink, whereby it is possible to achieve an increase in successive ejection speed, that is, an increase in printing speed.

What is claimed is:

1. A head tip having a structure in which a driving voltage is applied to electrodes formed on side walls of a chamber defined by the side walls on a base plate, thereby changing the volume of the chamber and causing ink filled in the chamber to be ejected through a nozzle opening, wherein an ink chamber plate is joined to the base plate so that a common ink chamber communicating with one longitudinal end portion of the chamber is defined, and that a border portion where the chamber and the common ink chamber communicate with each other creates flow passage resistance in the ink.

2. A head tip according to claim 1, wherein the border portion has a plurality of through-holes.

3. A head tip according to claim 1, wherein the border portion is of a net-like construction.

4. A head tip according to claim 1, wherein the border portion includes a plate-like construction situated substantially at the center of the border portion and narrower than the longitudinal dimension of the border portion.

5. A head tip according to claim 1, wherein the base plate is formed of a piezoelectric ceramic plate in which grooves are formed to thereby define the chamber, and communication of the chamber with the common ink chamber is effected through an opening at one longitudinal end of the chamber and on the opposite side of the base plate.

6. A head tip according to claim 1, wherein the side walls formed of a piezoelectric ceramic are arranged on the base plate at predetermined intervals to define the chamber between the side walls, and the common ink chamber is defined on the base plate, the chamber and the common ink chamber communicating with each other at one longitudinal end of the chamber.
